(19) United States
(12) Patent Application Publication
(10) Pub. No.: US 2018/0064612 A1
(43) Pub. Date: Mar. 8, 2018

(54) Pacifier with downloadable voice and music and monitoring capabilities

(71) Applicant: Chris Coleman, Hastings, FL (US)

(72) Inventor: Chris Coleman, Hastings, FL (US)

(21) Appl. No.: 15/257,946

(22) Filed: Sep. 7, 2016

(51) Int. Cl. A61J 17/00

(52) U.S. Cl. CPC A61J 17/002; A61J 2200/70; A61J 17/008; A61J 17/005

(57) ABSTRACT

This device will be a nipple that will soothe a child while providing soft noise for the child as well as providing perhaps educational material at the request of the parent. The sound itself can be emitted through a speaker and can be done wirelessly through a variety of wireless means. Alternatively, a chip may also be used to store various sounds that can be changed at the request of the user either remotely or locally. Because the parent will want to know when the child falls asleep, the noise from the device will automatically shut off once the child has stopped sucking on the pacifier.

### BACKGROUND OF THE INVENTION

### A. Field of the Invention

This relates to a pacifier that can be used to soothe a child while at the same time be instructional. Pacifiers are commonly used by children during the formative years. In addition to a device that the child can suck on, the device can also be used to train the child regarding voice and language to help a child become accustomed to language. Additionally material can be downloaded by the parents or guardians directly to the device. Although language is discussed, the parent can download music for the child to hear. The parent can also use a remote control to download the material. In addition, the power source and memory that is used with this device can be separated from the pacifier so that the pacifier can be cleaned without any risk of damaging the electronics that are embedded in the pacifier.

### B. Prior Art

There are prior art references regarding pacifiers that produce sound. A representative example of this type of device can be found at Uhler, U.S. Pat. No. 5,662,685. This device is a pacifier that can play music and can be activated to play music remotely. It will be in the general shape using a nipple and a handle. In addition, it is discussed that the beeping would be a means for assisting in locating the pacifier as well as a means to illuminate the surface.

Another example in the prior art for locating the pacifier can be found at Jones, U. S. Publication 2007/0049972. Also, a pacifier that has sound-generated activity with a locator can be found at Harlan, U.S. Pat. No. 6,102,935. However, it improves upon this by enabling the device to be disinfected as part of the structure without destroying the device itself. Additionally, there will be a means to illuminate the device in the event the pacifier is lost.

### BRIEF SUMMARY OF THE INVENTION

Pacifiers are commonly used to soothe babies and are typically placed in the baby's mouth. This is a variation of this type of idea by using a pacifier that has the further capability of storing information within a portion of the pacifier. The type of material than can be downloaded includes the voice of a parent, music or a person reading a book for examples. A speaker will also be included and the parent can alter the volume of the sound using remote control capabilities.

This device will enable the parent to teach the child language while at the same time soothing a child. Additionally the material that can be downloaded can be changed by the parent using wireless technology that is prevalent today.

Because this device is placed in a child's mouth it is important to also be able to clean the device without damaging the power source or the electronic components of the device. The top portion of the device can be detached from the bottom so that the parent can clean and/or disinfect the pacifier.

This device can also be operated by a remote control device and the sound that is being emitted can be changed in terms of a chip or by using wireless capability. Additionally, because a power source must be used, the power source may be rechargeable.

In addition, there is also a means to illuminate the device in the event it is misplaced or lost. This means to illuminate can be activated remotely.

Sometimes children will take a baby bottle or infant cup to his or her room and fall asleep while using the bottle or cup during normal feeding. A means to notify the parent when the child is done using the pacifier or when the child has fallen asleep will also be provided. This will enable the parent to know when the child is done and no longer using the device.

With this device once the child stops holding the device for a predetermined period of time because the child has fallen asleep the sound being emitted will cease.

### BRIEF DESCRIPTION OF THE DRAWINGS

FIG. 1 is an isometric view of the device.

FIG. 2 is a side view of the device.

FIG. 3 is an exploded view of the device showing the electronic components being removed from the pacifier portion of the device.

FIG. 4 is a front view of the device.

FIG. 5 is a back view of the pacifier.

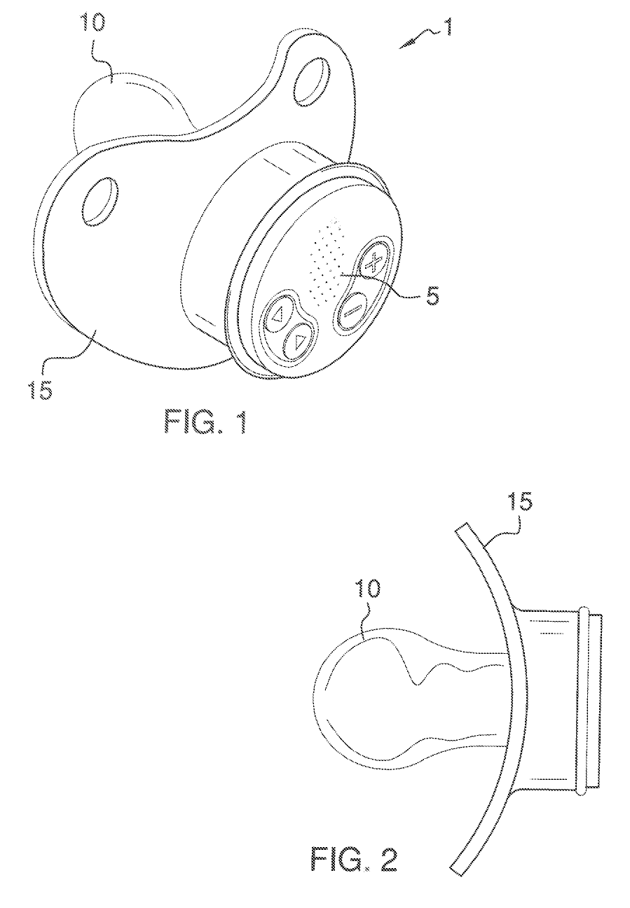

### NUMBERING DESCRIPTION

1 Device
5 Speaker
10 Nipple
15 Shroud
20 USB Port
25 Volume Control
30 Play Selector

### DETAILED DESCRIPTION OF THE EMBODIMENTS

This device 1 is a pacifier, which is commonly used by parents soothe children, usually infants. As the child uses the pacifier the child perfects the sucking action that is necessary for the development of a child.

This device, however, allows the parents the added features of being able to teach the child language or music with the use of this pacifier.

This pacifier 1 has a nipple 10 that is inserted into the child's mouth and a shroud 15 that conforms to the general shape of a child's mouth. Often the pacifier will also have a handle that can be used to insert the pacifier into the child's mouth.

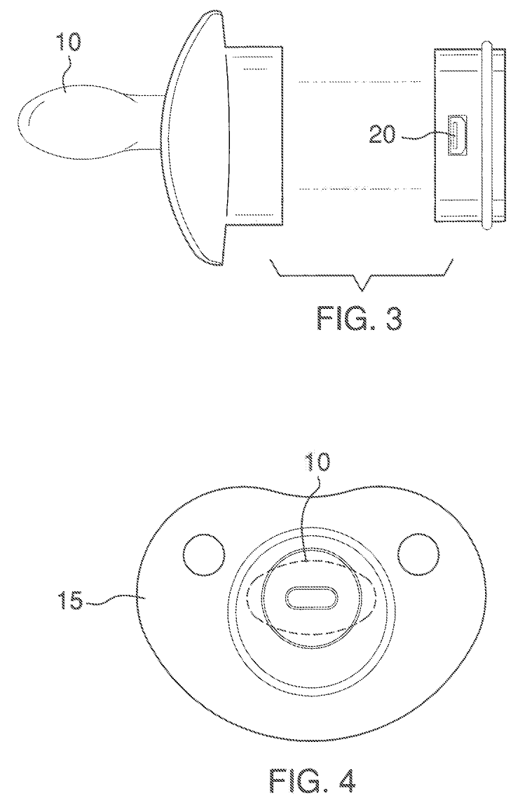

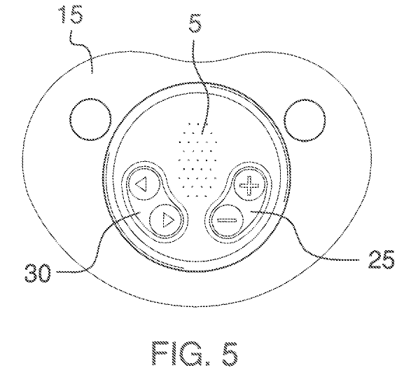

A detachable portion such as depicted in FIG. 3 allows the pieces of this device to be separated so that the portion of the pacifier with the nipple can be cleaned or disinfected by the parent without any risk of damaging the electronic components of the device.

In the detachable portion a controller is provided that will control all the electronic functions of the pacifier and enable the parent to download material onto the pacifier. This downloadable material can be as varied as desired by the parent. Possible examples may be prerecorded messages of love and affirmation by the parent, a parent reading a book, music for the child or a third party voicing a message.

Within the detachable portion will be a USB port 20 where the parent can download different types of material or recharge the power source that is contained in the detachable portion. Material can also be downloaded using wireless technology that is commonly used today. A speaker 5 will also be included in the detachable portion as well as a play selection button 25 and a volume control 25 such as depicted in FIG. 5.

Pacifiers are commonly misplaced and a chip to locate the pacifier will also be included as well as a small light (not depicted) to locate the device in a darkened area.

Additionally the parent can be alerted when the child stops using the pacifier when the sound of the pacifier stops after the child stops sucking after a predetermined amount of time.

When the parent wants to change the material that is downloaded this can be done using a remote control device or through the USB port. A chip or memory stick will be provided to store the plurality of files that will be used. This plurality of files will include audio files as well as music files, to name a few examples.

While the embodiments of the invention have been disclosed, certain modifications may be made by those skilled in the art to modify the invention without departing from the spirit of the invention.

The inventor claims:

1. A pacifier with downloadable voice and music and monitoring capabilities, which is comprised of:
a. a nipple;
wherein the nipple is placed in the child's mouth;
b. a shroud;
wherein the shroud conforms to the shape of a child's mouth;
c. power source;
wherein the power source is rechargeable;
d. detachable portion;
wherein the detachable portion can be separated from the shroud and nipple portion;
e. a controller;
wherein the controller is placed in the detachable portion;
f. memory storage;
wherein a memory storage is provided in the detachable portion;
wherein the memory storage contains a plurality of files;
g. USB port;
wherein a USB port is provided on the detachable portion;
g. a speaker;
wherein a speaker is provided;
h. play selector button;
i. volume control;
j. a light.

2. The device as described in claim 1 wherein the memory device is a memory chip.

3. The device as described in claim 1 wherein a predetermined set of sounds can be accessed using a wireless means.

4. The device as described in claim 1 wherein the power source is a battery.

5. The device as described in claim 1 wherein the plurality of files contain audio files.

6. The device as described in claim 1 wherein the plurality of files contain music files.

7. The device as described in claim 1 wherein the plurality of files contain story files.
